(19) United States
(12) Patent Application Publication
(10) Pub. No.: US 2001/0015553 A1
(43) Pub. Date: Aug. 23, 2001

(54) Coded means and system for neonatal care

(76) Inventors: Carlos J. Herreros Rodriguez, Madrid (ES); Pilar Perez Gay, Madrid (ES); Jesus Perez Rodriguez, Madrid (ES); Antonio Gonzalez Gonzalez, Madrid (ES); Orlando Saavedra Cantillana, Madrid (ES)

Correspondence Address: DENNISON, MESEROLE, SCHEINER & SCHULTZ, Suite 612, 1745 Jefferson Davis Highway, Arlington, VA, 22202, US

(21) Appl. No.: 09/741,142

(22) Filed: Dec. 21, 2000

(30) Foreign Application Priority Data
Dec. 22, 1999 (EP) 99500247.4

(51) Int. Cl. G09C 3/00; B42D 15/00

(52) U.S. Cl. 283/74

(57) ABSTRACT

Coded means and system for neonatal care, which consist of a mother record which contains all the physical elements for implementing the system which appears in illustrated and textual form on the back of the said mother record; in the obverse there is a record for the signature of the attending health official, a self-copying record with a fixed part and other separable parts and, essentially, a self-adhesive label, cleverly stamped out or perforated in order to be divided in sequence for different supports, these parts being coded with the same visible code and with invisible microcodes which are independent or shared and intended to be attached to the mother record itself, to the record file, to the mother's bracelet, to the child's bracelet and to the cord clamp.

As a consequence of incidents and failures in systems for the control of newborn babies, government regulations have had to be made which require the exceptional strictness of zero failures in ensuring the maternity of the newborn child and vice versa.

The system, according to the invention, which is completely original and novel throughout the world, pursues these objectives and ensures the certainty of the mother-child binomial, by ensuring the match from the time of birth until both leave the hospital.

The invention which is the object of this patent is specially designed to eliminate any possibility of error in identification and custody, even in situations of abnormality and unforeseen chaos and disorder.

It is designed for use in large centres but is, logically, also perfect for small ones.

The object, according to the invention, consists of a coded physical-logical system contained in a supporting mother record of all the physical elements that make up the system which in addition includes the systematic method of use, which also forms part of the mother record.

### BACKGROUND OF THE INVENTION

With respect to physical control systems for neonatal care, the most common and widespread is the record file of the mother, which at the time of birth is associated with a set of bracelets which are placed on the mother's wrist and on the child's ankle when the latter is born (normally after the umbilical cord is cut and even after washing), on which the mother's name appears, which must coincide with the name which appears on that of the mother. Except when there is an allocation error. Except for an identification error at registration. Except in the case of loss, mislaying, confusion, forgetting, erasure or other incident that occurs subsequently, making correct matching difficult, if not improbable.

However, the system according to the invention proposed does not exclude a set of bracelets, which nevertheless should provide effective means of fastening or unlosable characteristics once they are closed.

### INVENTIVE STEP

The activity of the invention is directed towards a solution which ensures the mother-child binomial from the time the latter is born until both leave the hospital.

It consists of a coded adhesive label (codes and microcodes) cleverly stamped out so as to be broken up in sequence in front of witnesses, and different supports such as: mother record, file, wristbands and umbilical cord clamp.

The newborn's wristband with a label and respective code and the label for the clamp, essentially, are detached from the mother's wristband after birth and in her presence.

### DESCRIPTION OF THE INVENTION

As may be deduced from the preliminary explanation, the invention consists of setting up physical means essentially based on a self-adhesive label that is cleverly or essentially stamped out so as to be broken up in sequence into at least five fragments or preferably into five fragments, of which one is permanently united with the mother record, where in addition the system incorporates a self-copying record and a record with the signature of the medical staff member who attended the birth, who will carry out the operation of applying the system.

The stamped out label, self-adhesive according to the invention, has essentially printed on all its fragments the same visible code, which constitutes a multiple correlation for repeated identification of mother and child and multiple invisible microcodes, which are even shared between the fragments of the label, of high precision and security, and which require to be read with a thread counter or an ultraviolet reader.

The said mother record, according to the invention, together with all its elements, label, self-copying record and signature record is covered with a protective film and the third and fourth fragments of the label are joined to the respective bracelets of the child and the mother, preferably to ensure and facilitate better handling on the part of medical staff and to ensure implementation in the planned manner, keeping the three remaining fragments together until the very moment of their application.

On the back of the mother record, according to the invention, the “method of use” appears in textual and illustrated form and includes the systematic procedure, which is the object of the invention, for applying the said coded means.

The self-copying record of the mother record, according to the invention, is a small document with a fixed part and a separable part with two symmetrical fields for noting the mother's data or lack of the same, her anonymity, or lack of identification. Each field is cut in two through the respective perforated or tear-along line and each part is introduced into the pockets of the respective bracelets, a fixed (double) inscription remaining in the mother record.

According to the invention, the record of the signature of the staff member or health official is a printed space in the mother record itself. The signature is placed there before the coded distribution process is begun, ensuring that an external visible code identical to that of the mother and the newborn is placed securely and in front of witnesses, preventing possible human errors or making up for a lack of documents.

It gives a 100% guarantee of the mother-child binomial throughout their stay in the medical centre, and independently of this, of their nominal and civil identity, and of related documents.

The label, cleverly broken up by means of tear-off segments, according to the invention, is attached to the mother record by the first of the five fragments which, it is recommended, also according to the invention, is carried by the said label, the second being intended for attachment to the mother's file; the third is attached to the child's bracelet and the fourth to that of the mother, both being in place in the mother record; the fifth is to be attached to the umbilical cord clamp.

All the divisions of the label, as reiterated throughout this specification, have the same visible code, different invisible microcodes, and at least in each fragmentation line, a common invisible code, which is legible only with a thread counter or ultraviolet reader.

The methodology of procedure appears in illustrated form on the back of the mother record.

### PROCEDURE OF THE INVENTION

By following the procedure explained in “Mode of Use”, which is printed on the back of the mother record, all cases of the mother-child binomial are ensured and responsibility for custody of the newborn, acquired by every maternity centre from the time of birth, is safeguarded.

The procedure, according to the invention and inseparably from the means expounded in the foregoing specification, consists of a series of steps which must be observed in the following manner:

1 Remove the protective film.

2 Sign the mother record (the signature of whoever opens it).

3 Write the mother's name (if known; if not, put N/D, no documents) on the self-copying paper and introduce it into the pocket of the bracelets (one part in each of them).

4 Extract the unit consisting of label and bracelets, detaching it from the first code, which remains attached to the mother record.

5 Stick the second code in the file and pull off both bracelets, without separating them.

6 Place the bracelet on the mother (leaving that of the newborn attached to it, and also the adhesive fragment for the cord clamp).

7 After the birth, pull the newborn's bracelet off the mother's bracelet and put it on.

8 Pull out the label for the cord clamp which is still attached to the mother's wristband and put it on.

According to the development of the procedure, all the fragments of the label contain:

The same visible code, mother record, file, mother's wristband, newborn's wristband and cord clamp.

The same invisible multiple code distributed on the surface of the label and legible only with a thread counter.

The same invisible code, which is shared and legible only with an ultraviolet reader.

Below we will give a more extensive idea of the characteristics of the invention, where we refer to the sheet of drawings which accompany this report, in which in a somewhat diagrammatic way and only by way of example, the preferred details of the invention are represented.

### IN THE DRAWINGS

FIG. 1 is a plan view of the unit comprising the mother record with all its integral elements for effective custody of the mother-child binomial.

FIG. 2 is a plan view of a set of labels, according to the invention, in an horizontal presentation.

FIG. 3 is a view of the same set as in the foregoing figure, mounted upon the respective bracelets.

FIG. 4 is a view of the diagram with the illustrated development of all the steps according to the procedure of the invention.

### PREFERRED EMBODIMENT OF THE INVENTION

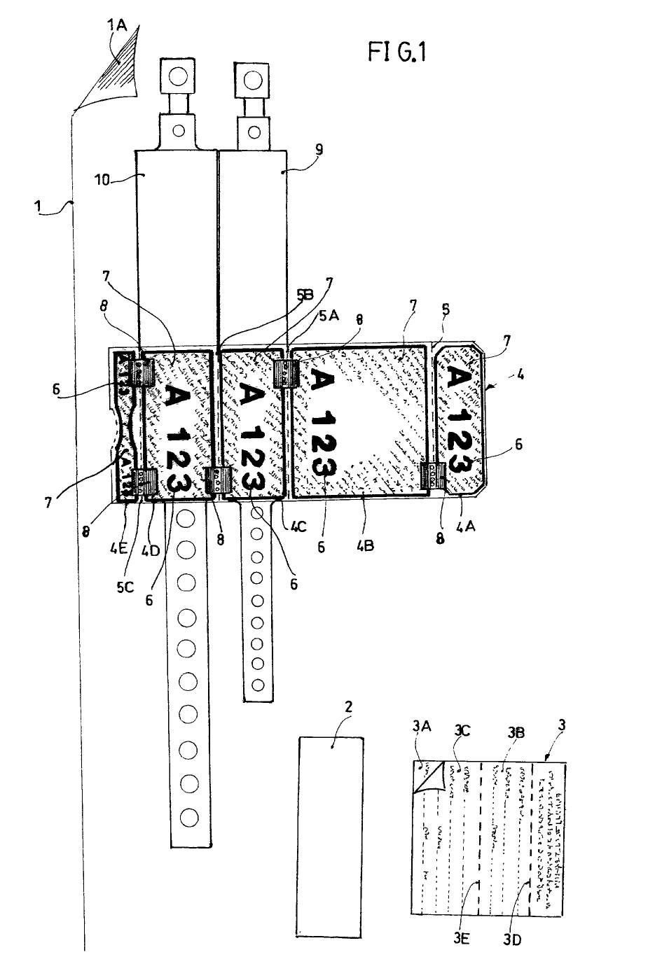

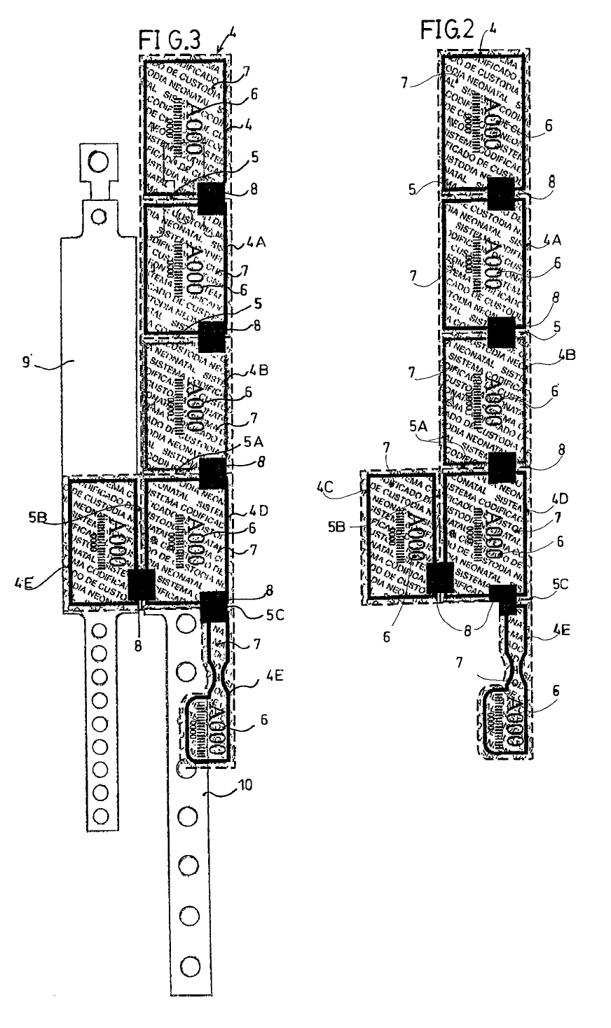

In accordance with the foregoing drawings, FIG. 1 shows us the physical means for implementing the system of effective custody of newborn babies, distinguishing (1) the mother record and (1A) the mother record's protective film.

(2) indicates the section for the signature of the health official and (3) the self-copying paper for the mother's particulars or data that is relevant to her or her anonymity or lack of documents.

(4) indicates the fragmentable self-adhesive label which bears the visible and invisible “single” code, which is the reason for the label.

The self-copying paper (3) has a copy backing (3a) with a coat of emulsion on the mother record itself (1) and is made up of two identical fields (3b) and (3c) which may be detached along a tear-off line (3d) and separated by the tear-off line (3e). Each part (3b) (3c) is introduced into the respective pocket of the wristbands or bracelets (9) and (10) for the newborn and the mother respectively, situated in the opposite part (not represented), of the bracelets (9-10) shown in FIG. 1.

The self-adhesive coded label (4) is made up of the fragments which are divisible in sequence (4a), (4b), (4c), (4d) and (4e), joined by tear-along lines, such as perforated lines, respectively (5), (5a), (5b) and (5c).

All these fragments (4a, 4b, 4c, 4d and 4e) present an identical visible highlighted code (6); multiple and identical or related invisible codes (7) and a common invisible identical code (8) in each perforated line (5, 5a, 5b and 5c).

Fragments (4c and 4d) of the label (4) are joined to the bracelets or wristbands (9) and (10), respectively, intended for the child and the mother, also respectively.

Fragment (4a) remains joined to the mother record (1); fragment (4b) will be stuck to the mother's file and fragment (4e) will be fastened to the cord clamp, for which purpose it has two symmetrical coded parts which, folded upon themselves around the vertex of the clamp, stick one against the other.

It is clear that the multiple repetition of the code ensures the effectiveness of mother-child custody throughout their stay in the hospital, but also the means of the invention and the system are designed to be associated, if desired, with a process of electronic reading which could be implemented.

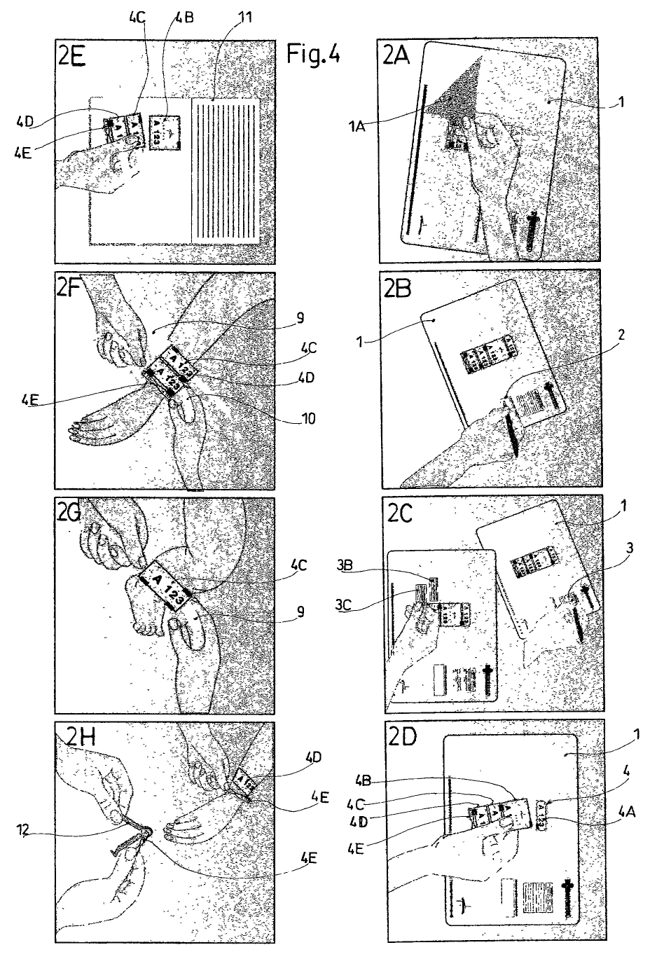

In accordance with the drawings of FIG. 4, the system's methodology is expressed graphically and unequivocally in the following order:

2A - Remove the protective film (1A).

2B - Sign the mother record (1) in the record (2).

2C - Write the mother's name or indicate her absence of data or lack of documents in fields (3b) and (3c) of the self-copying paper (3) and introduce each part (3b), (3c) in the pocket (not represented) of the bracelets (9 and 10).

2D - Extract the unit comprising the labels (4b, 4c, 4d and 4e) and bracelets (9 and 10) detaching them along the line (5) of the first code (4a), which will remain attached to the mother record (1).

2E - Stick the second code (4b) and successive ones in the required documents (11) and pull off both bracelets (9, 10) and the code (4e), without separating them.

2F - Place the bracelet (10) on the mother (leaving the newborn's bracelet (9) and code (4e) attached).

2G - After the birth, pull the newborn's bracelet (9) off the mother's wristband (10) and put it on.

2H - Pull off the fragment (4e) of the label for the cord clamp (12) which is still attached to the mother's wristband and put it on.

Logically, when the mother enters the delivery room, the person responsible for attending her will only have to take out a coded mother record which the hospital will have in store, assigned or controlled. From that time they will have only to carry out the foregoing procedure.

The nature of the invention having been appropriately described, it is stated for the relevant purposes that the same is not restricted to the exact details of this explanation, but on the contrary, modifications may be introduced into the invention which are considered appropriate, provided that they do not alter the essential characteristics of the same, which are claimed hereinbelow.

1. Coded Means and system for neonatal care which consists of a mother record sheet, plate or printed paper (1) characterised in that on the obverse all the physical means are to be found for carrying out the said custody sealed by a transparent film (1A), and on the reverse side it bears the development of the system or method of use, appropriately illustrated, in preferably eight stages or steps (2A to 2H), both inclusive.

2. Coded means and system for neonatal care, as claimed in claim 1, in which the physical means of care are characterised in that they are made up of a fixed space (2) to receive the signature of the person responsible; a self-copying record (3) for the mother's data or particulars and a self-adhesive label (4) subdivided into preferably at least five fragments (4a, 4b, 4c, 4d and 4e), which may be divided in sequence, separated by respective tear-off lines, for example perforated ones (5, 5a, 5b and 5c).

3. Coded means and system for neonatal care, as claimed in claim 2, in which the self-copying record (3), is characterised in that it is constituted by a copying paper, which has a fixed copy (3a) on the mother record (1) and is subdivided into two equal fields (3b and 3c) which have a tear-along line (3d) on the record (3) and a separation line (3e) between the parts (3b, 3c).

4. Coded means and system for neonatal care, as claimed in claim 2; the self-adhesive label (4), divided into fragments (4a, 4b, 4c, 4d and 4e) is characterised in that all of them bear the same visible and highlighted code (6); the same or a related invisible multiple code (7) and the same shared invisible code (8) in each tear-along line (5, 5a, 5b and 5c), the said code being the same in all of them.

5. Coded means and system for neonatal care, as claimed in the foregoing claim; the fragments of the coded self-adhesive label (4) are characterised in that the initial or first fragment (4a) is fixed to the mother record (1) and the third and fourth fragments (4c and 4d) are mounted on the bracelets or wristbands (9 and 10), respectively, of the child and mother respectively.

6. Coded means and system for neonatal care, as claimed in claim 1; the system according to the invention is characterised in that it has the following stages or steps:
Remove the protective film (1A) from the mother record (1).
Sign the record (2) of the mother record (1).
Fill out the files (3b, 3c) of the self-copying record (3) with the mother's data, if they are known, or note the absence of these, and introduce them into the pockets of the bracelets or wristbands (9, 10).
Extract the unit comprising the label fragments (4b, 4c, 4d and 4e), detaching them from the first code (4a), which remains attached to the mother record (1).
Stick the second code (4b) on the record file (11) and pull off both bracelets (9 and 10) and the fifth fragment (4e), without separating them.
Place the bracelet (10) on the mother, leaving that of the newborn (9) and fragment (4e) attached.
After the birth, pull the newborn's bracelet (9) off the wristband (10) of the mother and put it on.
Pull off the label fragment (4e) for the umbilical cord clamp (12) which is still attached to the mother's wristband (10) and put it on.
